(19) United States
(12) Patent Application Publication
(10) Pub. No.: US 2002/0133597 A1
(43) Pub. Date: Sep. 19, 2002

(54) Global storage system

(76) Inventors: Nikhil Jhingan, Singapore (SG); Vinod Udharam Vasnani, Singapore (SG)

Correspondence Address: CONLEY ROSE & TAYON, P.C., P. O. BOX 3267, HOUSTON, TX, 77253-3267, US

(21) Appl. No.: 09/808,553

(22) Filed: Mar. 14, 2001

(51) Int. Cl. G06F 15/16; G06F 15/173

(52) U.S. Cl. 709/228; 709/203; 709/226; 709/224

(57) ABSTRACT

A system for storing and retrieving user-specific content in a client-server computer network according to a computer network architecture is described. The system comprises means for sending, from a first computer, a request relating to user-specific content to a second computer in a client-server computer network, and means for determining a third computer in the client-server computer network which is geographically proximal to the first computer. The system also comprises means for redirecting, by the second computer, the request to the third computer, and means for providing a user-specific content transaction between the first and third computers.

### FIELD OF THE INVENTION

The invention relates generally to information storage and retrieval in a computer network. More particularly, the invention relates to a system and method of storage, manipulation, and distribution of user-specific content (USC) on the Internet.

### BACKGROUND

The World Wide Web (WWW or Web) is fast becoming not only the Internet's multimedia information retrieval system, but also the Internet's personal and group information storage and retrieval system. In the Web environment, client machines effect transactions with Web applications through Web servers using HyperText Transfer Protocol (HTTP), which is a standard application protocol facilitating the storage of and access to files (e.g. document, images, music, sound, video, etc), using a standard document description language known as HyperText Markup Language (HTML). HTML provides the rules for basic document description and formatting, and allows a document developer to design and provide forms to, among other things, indicate and attach files for uploading to Web applications, specify links for retrieving files from Web applications, and specify links to other Web applications. A Web site is a computer system that makes a collection of files available through a Web server. A Web application is a Web site that is interactive and provides an application as a service to users through a Web server. A typical example of a Web application is one that uploads, downloads and shares files and other forms of digital media. On the Internet, a Uniform Resource Locator (URL) identifies the network path to any Web resource. A URL is therefore a special syntax for defining an Internet connection. With a HTML-compatible Web browser, such as Netscape Communications Corporation's Netscape Communicator or Microsoft Corporation's Internet Explorer, a client machine may specify a connection with a Web application via a URL. The client machine, in effect, makes a request to the Web site or application identified in the URL. In return, the client machine receives a response such as a document or other objects formatted according to HTML.

The client machine may via the URL make requests to upload files which typically include documents, pictures, images, video, and the like files. Similarly, URL requests may be made to download or retrieve files that have previously been uploaded.

It is conventional practice for a Web application to improve content delivery performance by pushing Web application content to locations geographically close to users. This model works well for Web applications or sites in general that have same or similar content to be delivered to and viewed by many users.

For example, a Web application provider typically mirrors the Web application content at a remote Web server which is located as close to as many users as permissible. For the Web application provider, building copies of the Web application's content in content storage facilities such as hosting farms in different locations, domestically or internationally, is one way of placing content closer to users. These copies are placed on Web servers known as mirror sites. Unfortunately, these mirror sites place undue economic and operational burdens on Web application providers due to a lack of economies of scale. Economically, the overall cost of mirroring content to one mirror site is more than twice the cost of maintaining one primary Web application from which the content is mirrored. The additional costs are incurred because the Web application provider must enter a separate contract with a separate and remote hosting facility, thereby incurring additional overhead expenses in keeping the primary and mirror sites synchronized.

Another conventional practice for improving content delivery performance is related to Web application content delivery caching. One way of applying content caching to improve content delivery performance relates to storing frequently accessed data on caching servers which are located close to users. A response to an initial request for data is generated by an originating Web application and a copy of the content in the response is also stored on the caching servers. The caching servers thereafter respond to subsequent requests for the same content from the same locations whereby the content is served from the caching servers. Content caching is feasible for Web applications that serve similar content to a large number of users. Also, content caching involves economies of scale in storing frequently accessed content and simply delivering the same content locally once the content is cached, thereby providing savings on bandwidth charges. Typically, content caching involves Web applications purchasing caching servers from caching equipment providers and installing these at data centers at frequently accessed locations.

Another way of applying content caching is to procure and use the services of content caching companies which offer content caching as a service. These companies typically have caching servers already deployed in various locations around the world, and offer the services of caching servers to Web applications to cache frequently accessed content.

Content mirroring and caching help speed up content the delivery of frequently accessed content. Such conventional practices are based on the principle that frequently accessed content such as image files are stored in caching servers in locations close to users. Such proposals work well for content that is from a content creator at one location to be served to a large number of viewers in many locations.

However, the conventional practice of content caching is not feasible when applied to content that is user-specific in nature, i.e. content that is created by one user to be accessed by the same user or by a few users, such as images, audio, video, files, document links, or the like content. Content caching by nature is typically unsuitable for applications in which there are frequently files upload, and especially when the content includes files that are uploaded for retrieval later by the same user or a few users. In essence, content caching provides benefit in a one-to-many user access model, but not in one-to-one user or one-to-few user access models.

There is therefore a need to address the problem associated with content delivery performance in relation to user-specific content (USC) that is not addressed by conventional practices.

### SUMMARY

In accordance with a first aspect of the invention, there is provided a method for storing and retrieving user-specific content in a client-server computer network. The method comprises the steps of sending, from a first computer, a request relating to user-specific content to a second computer in a client-server computer network, and determining a third computer in the client-server computer network which is geographically proximal to the first computer. The method also comprises the steps of redirecting, by the second computer, the request to the third computer, and providing a user-specific content transaction between the first and third computers.

In accordance with a second aspect of the invention, there is provided a system for storing and retrieving user-specific content in a client-server computer network. The system comprises means for sending, from a first computer, a request relating to user-specific content to a second computer in a client-server computer network, and means for determining a third computer in the client-server computer network which is geographically proximal to the first computer. The system also comprises

means for redirecting, by the second computer, the request to the third computer, and means for providing a user-specific content transaction between the first and third computers.

### BRIEF DESCRIPTION OF DRAWINGS

Embodiments of the invention are described in greater detail hereinafter with reference to the drawings, in which:

FIG. 1 illustrates the components of a client-server system configured according to an embodiment of the invention;

FIG. 2 illustrates a session between a client machine and a Web application in the client-server system of FIG. 1;

FIG. 3 is a simplified representation of a Web page being delivered in the system of FIG. 1, wherein the Web page comprises a base document described using a markup language, a set of embedded objects, and an upload box;

FIG. 4 is a high-level block diagram of a global distributed user-specific content (USC) system deployed in the system of FIG. 1;

FIG. 5 is a data flow diagram illustrating new user registration in the distributed USC system of FIG. 4;

FIG. 6 is a flowchart illustrating the manipulation of files or folders on the distributed USC system of FIG. 4;

FIG. 7 is a data flow diagram illustrating the distributed USC system of FIG. 4 enabling Application Web servers to respond to an HTTP request for a Web page; and

FIG. 8 is a data flow diagram illustrates the downloading of a shared resource that is replicated in the distributed USC system of FIG. 4.

### DETAILED DESCRIPTION

A computer network architecture or framework providing a distributed USC system according to an embodiment of the invention that allows for the storage, manipulation, and delivery of user-specific content on a global scale is described hereinafter to address the foregoing problem. The distributed USC system allows Web-based applications, content providers and the like to store, manipulate, manage, and retrieve user-specific content from geographically distributed servers known as USC servers. Moreover, the locations of the distributed USC servers for storage and delivery of user-specific content are automatically located without any effort or overhead on the part of a Web application provider.

There are a number of advantages associated with adopting the computer network architecture or framework or deploying the distributed USC system in a client-server system.

An advantage is the provision of a computer network comprising a large number of distributed Web-based servers that forms a fault-tolerant infrastructure designed to store, manage, manipulate and deliver user-specific content efficiently, effectively and reliably to users.

Another advantage is the provision of a method for storing and delivering user-specific content on the Internet. The computer network architecture or framework provides at least one method for storing on and delivering from servers that are closest to users, user-specific content

Another advantage is the provision of a computer network architecture or framework that allows the storage and delivery of user-specific content close to users. The computer network architecture allows Web applications to develop a large user base without the need to contend with issues such as building massive infrastructure to handle a growing user base.

Another advantage is that the computer network architecture speeds up the storage and delivery of user-specific content of Web pages, and allows Web applications to serve the Web pages reliably and economically from USC servers located close to Users.

Another advantage is the provision of selective replication of user-specific content based on various needs such as speed of delivery and redundancy. The computer network architecture or framework provides for Web applications to allow users to share out data to other users by having the shared data replicated on a USC server closest to the other users so that the sharing recipient user may better and more quickly retrieve the data. The computer network architecture also allows Web applications to mirror the user's data in entirety to selected sites either for redundancy or for quicker access at frequently visited locations.

Another advantage is that a Web application may shift the burden of user account management to a distributed USC server network according to the computer network architecture or framework.

Another advantage is the ability to store, manage, manipulate and deliver user-specific data without disrupting a Web application provider's direct relationship with users.

Another advantage is the provision of a distributed scalable network infrastructure for the Internet that shifts the burden of storage and retrieval of user-specific content from a Web application provider to a network of numerous USC servers preferably deployed worldwide on a global basis.

It is therefore advantageous to provide the computer network architecture or framework and the attendant distributed USC system to enable Web application providers to provide Web applications that respond quicker to users when dealing with user-specific content. The global computer network architecture allows Web application providers to retain control over the Web applications while shifting the burden of providing storage and minimizing bandwidth in relation to user-specific content from the Web application providers to a computer network of globally deployed and distributed USC servers that serve as a distributed USC system based on HTTP.

A client-server system according to the computer network architecture or framework preferably comprises a set of USC servers, deployed globally, operating as a distributed USC system. Web application providers who wish to use this global computer network architecture are required to write a set of HTTP based application program interfaces (APIs) to the distributed USC system. The user-specific content is then automatically created, uploaded or stored on USC servers closest to users.

Typically, user-specific content that is served from Application Web servers comprises HTML pages that include embedded objects such as pictures, sound clips, movie segments, and links to files and/or forms for uploading such objects on the USC servers. In a Web-based client-server system in accordance with the computer network architecture or framework, base HTML pages are served from Application Web servers, while one or more such objects are served from or uploaded to distributed USC servers located closest to users. By serving the base HTML pages from the Application Web servers, Web application providers still maintain control over the Web applications while offloading the task of managing, manipulating, and delivering user-specific content to the USC servers in the distributed USC system.

The determination of which USC server in the distributed USC system to serve user-specific content to a user is affected by other resources in the framework. In particular, the distributed USC system includes another set of servers that are configured to provide a service known as Domain Name Service (DNS). To locate the appropriate USC server, the DNS servers determines a user's location in relation to the network of distributed USC servers and identifies which USC server should respond to a series of redirect calls made from the user's Web browser. With this series of redirect calls, the USC server that provides the quickest response to the user may be determined.

Once the USC server that provides the quickest response is determined, the Web application makes an API call to create an account on this USC server that allows storage and retrieval of user-specific content. The API call is made in a secure manner because the Internet Protocol (IP) address and application identification (ID) of the Web application are used to verify that the API call is made from a valid Web application. In addition, API calls are also encrypted. These API calls are similar to HTTP requests for Web pages, in which Web pages provide the response to the API requests. In effect the API calls may be viewed as remote procedure calls via HTTP.

A series of servers hereinafter termed as master servers are used for maintaining user account information for the Web application. These master servers are used internally in the distributed USC system to determine the location at which existing users reside. A Web application may make API calls to any USC server in relation to an existing user to determine on which location server the existing user account resides. A Web application also only interacts with the USC servers.

When the user subsequently connects to the Web application, the Web application performs a login for that user to the appropriate USC server on which the user-specific objects reside. An authentication ID is provided, preferably by way of a 128-bit alphanumeric string, which is used to verify the Web application and the user. With authentication, various API calls that emulate various function calls typically found in any file management system may be made, such as file or folder operations regarding user-specific objects. In addition, API calls for download and upload of user-specific objects are provided as well. In this way, the Web application provider maintains a direct relationship with users while by providing manipulation of user-specific content at locations close to the Users.

In this manner, user accounts are created and managed in a globally distributed scale, therefore allowing for the distribution of user-specific objects across a large number of USC servers. This provides for improved reliability and availability of user-specific content.

In addition, user-specific content may also be replicated on various USC servers. When checking a master server for information of a USC server relating to a particular user account, the master server may suggest alternative USC servers from which the user may access the replicated user-specific content if the primary USC server is not accessible or in operation. Hence, the availability of user-specific content is enhanced, thereby providing for a fault tolerant file system for user-specific objects as well.

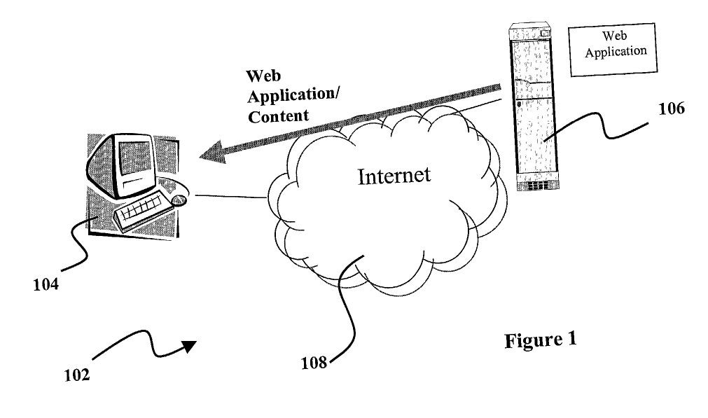

To better describe the computer network architecture and the distributed USC system hereinafter, reference is made to FIGS. 1 to 8.

A client-server system 102 is illustrated in FIG. 1. A client machine 104 is connected to a Web application 106 via a network 108 in the client-server system 102. For illustration purposes, the network 108 may be the Internet, an Intranet, an Extranet, or the like network. An Application Specific Provider (ASP) or a Web Portal is an example of the Web application 106 which is accessible by the client machine 104. The client machine 104 is shown in FIG. 1 as a desktop computer with a Web browser that is a software tool used for accessing the Web application 106 or other Web applications through the network 108. The client machine 104 may also be a notebook computer, a handheld computing device such as a Personal Digital Assistant (PDA), a wireless communications device such as a mobile phone, an Internet Appliance (IA), or any such devices connectable to the network. A software tool may be any software that is able to provide or facilitate communications over the network 108 via protocols such as HTTP.

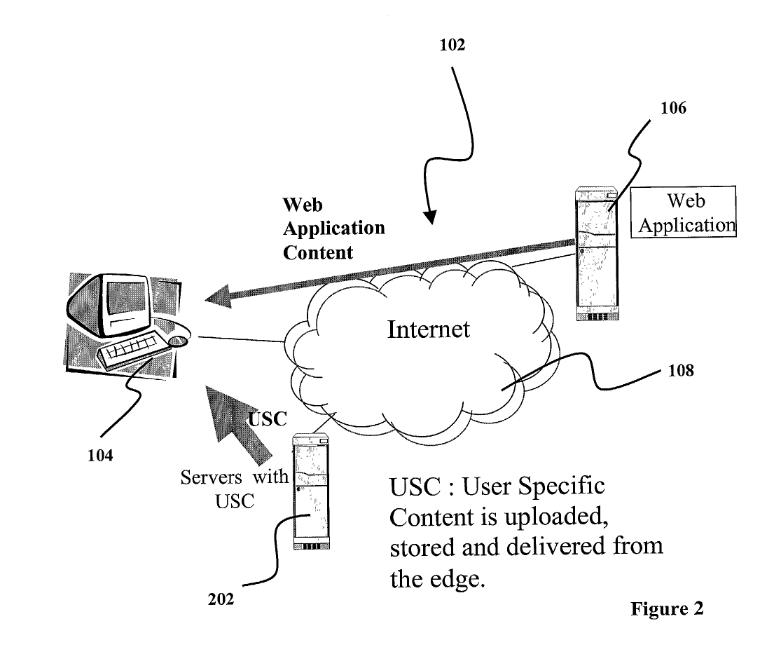

FIG. 2 illustrates a session that occurs between the client machine 104 and the Web application 106 involving content that is user-specific. Preferably, a user account is first created on the Web application 106 for a user who controls or uses the client machine 104. Once the user account is created, the session continues, which initially involves the authentication of a set of login user ID and password supplied by the user upon login. This then provides the user access to Web pages from the Web application 106 and a server 202 that contains embedded objects and/or links to such objects such as images, audio, video, files, documents or the like files that are user-specific in nature. The server 202 is described in greater detail hereinafter.

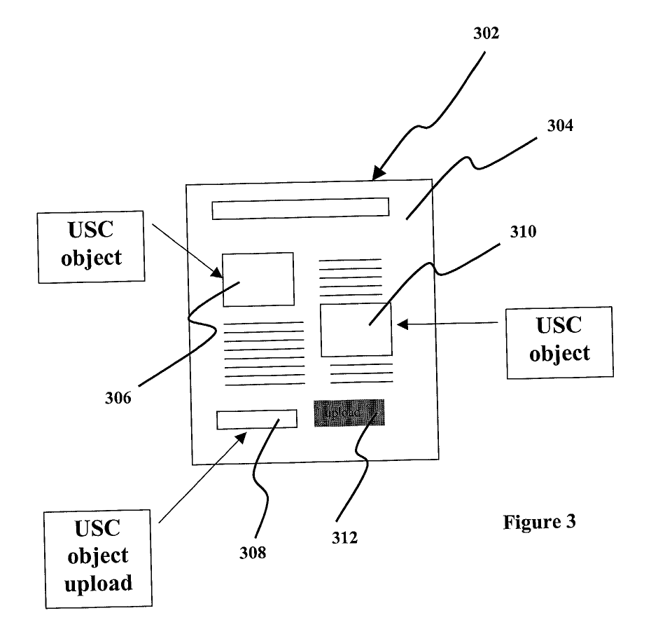

As shown in FIG. 3, a Web page 302 typically comprises a base document 304 described using a markup language such as HTML, and a number of embedded objects 306, 308 and 310 such as images, audio, video, files, document links, or the like objects that are user-specific in nature. Thus the Web page 302, or any other Web page of such nature, attributes 80% to 90% of the document size to user-specific embedded objects 306, 308 and 310. Each of these user-specific objects 306, 308 and 310 is an independent object on the Web that may be separately uploaded or retrieved. The common behavior amongst the client machine 104 and other Web clients, therefore, is to fetch the base document 304, and then immediately fetch the embedded objects 306, 308 and 310, which are conventionally located on the same Web Application 106. Where an upload button 312 is provided on the Web page 302, clicking the upload button 312 invokes a program execution to perform the upload. This is conventionally done so that the upload occurs on the Web Application server 106. In a similar manner, links to other documents and objects 306, 308 and 310 such as images, audio, video and the like objects, when selected, conventionally cause the document or object to be served from the Web application 106.

In accordance with the computer network architecture or framework, however, the base document 304 is preferably served from the Web application 106, whereas the embedded objects 306, 308 and 310 and links are served from the USC server 202 that is geographically close to the client machine 104.

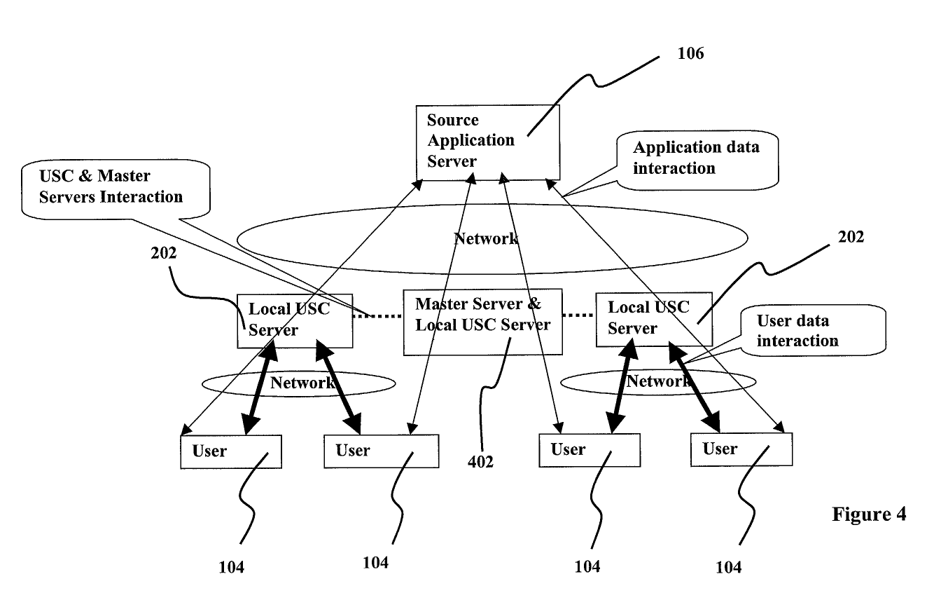

With reference a high-level block diagram shown in FIG. 4, this operation is achieved by deployment of the distributed file system, hereinafter known as a distributed user-specific content (USC) system. The distributed USC system comprises a set of widely-deployed servers or server resources that form a large, fault-tolerant infrastructure designed to serve user-specific objects more efficiently, effectively and reliably to the users 104. In effect, the distributed USC system serves as a HTTP-based file system for Web application 106 providers. The servers may be deployed globally, or across any desired geographic regions. The distributed USC system also provides a distributed computer network architecture or framework for intelligently creating, storing and retrieving such user-specific content.

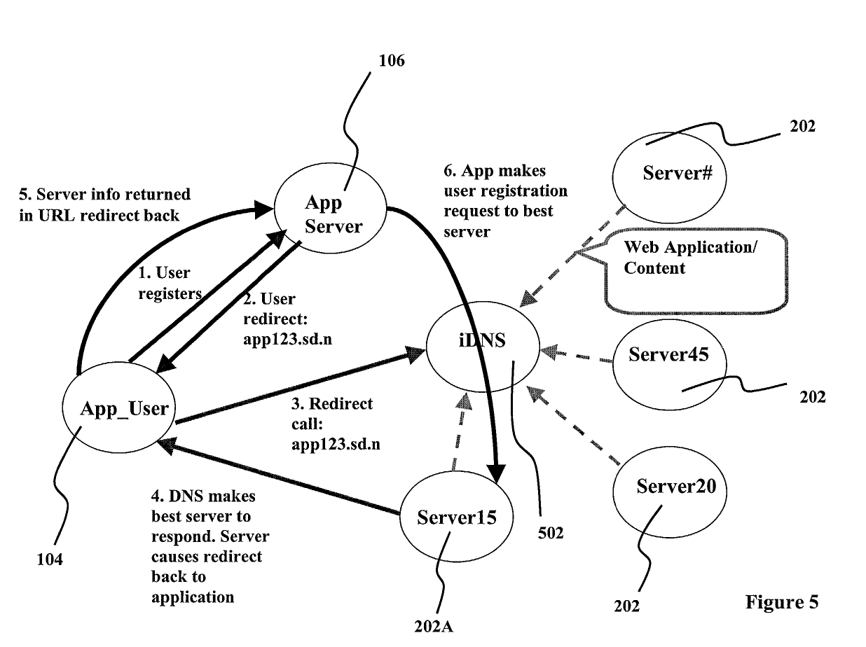

To this end, the distributed USC system consists of three types of servers or server resources: Master servers 402, USC servers 202, and DNS servers (shown in FIG. 5). These servers are not limited to being on separate physical machines.

An example to illustrate how the Web application 106 registers to use and uses the distributed USC system is described in greater detail hereinafter. As an example, the URL of the Web application 106 is www.app.com. The Web application 102 upon registration with the distributed USC system is given a unique application ID and URL to use to make API calls to the distributed USC system. The distributed USC system, as well as the DNS servers, is also setup to receive API calls from the Web Application servers. The session begins with a new user 104 registering for the first time with the Web application 106. The Web application 106 first detects an appropriate USC server 202A that is closest to the new user 104 to create an account for the new user 104, and FIG. 5, a data flow diagram, provides the illustration for this process.

This process is carried out by redirecting the user 104 to a pre-specified URL, being app123456.xxx.yyyy.zzz.net in this instance, which is provided to the Web application 106 upon registration to use the distributed USC system. The prespecified URL eventually hits intelligent DNS servers 502, which then direct the requested URL to the appropriate USC server 202A for responding. The appropriate USC server 202A is one that responds quickest from the user's perspective. This is determined by a series of software agents, which are basically a set of software routines, running in the USC servers 202 that measure the response relative to the user's client machine 104 either directly, if possible, or indirectly using the user's ISP's DNS server as a proxy. These software agents send out packets of information and measure the time taken for the USC servers 202 to connect to the user's ISP's DNS server, or measure the round-trip time taken for a data packet to reach the ISP's DNS server and back by using a ping test. Based on these time measurements, the USC server 202 with the shortest time measurement is asked to respond to the URL request. Such DNS servers 502 and agent software are known to those skilled in the art.

The appropriate USC server 202A, which is identifiable by sd12345.zzz.net in this instance, responds to the user and causes the user's client machine 104 to redirect the URL request to the Web application 106 with the USC server's 202A identification embedded in the URL:

www.app.com/newuserprocess.html?server=sd12345.zzz.net

The Web application 106 then makes an appropriate API call to that USC server 202A to create an account for the new user using a HTTP request:

d12345.zzz.net/user_register.api?application_id=123456&auid=john

with an optional password. This HTTP request then creates and allocates storage space on the USC server 202A for the new user. The response HTML page provided by the USC server 202A returns either a success or failure status for the HTTP request made by the Web application 106.

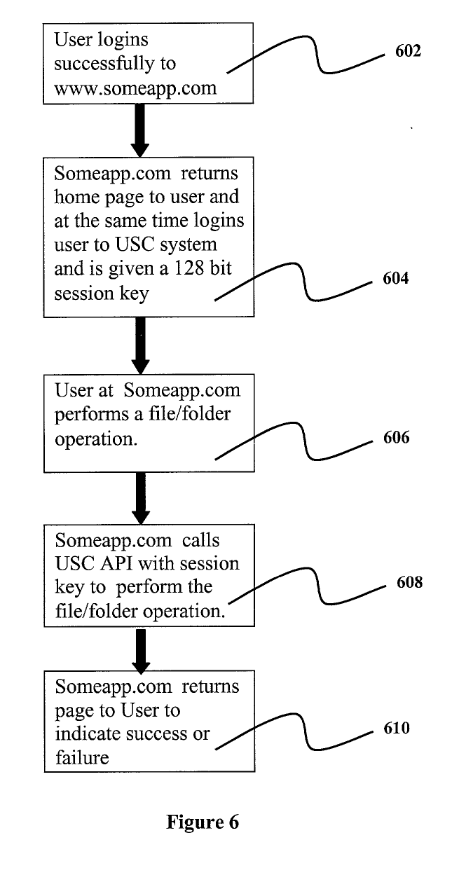

FIG. 6 is a flowchart illustrating a file management session between a user and the Web application 106 once a user is registered. As the user performs a login to the Web application 106 in step 602, the Web application 106 also performs a login at the USC server 202A identified by sd12345.zzz.net, where the user's storage space account resides. In return, the Web application 106 obtains from the USC server 202A an encrypted session key such as a 128-bit key in step 604, which is used for subsequent operations during the session.

Subsequently in step 606, as the user performs a file or folder operation, such as creating a folder, the Web application 106 makes an API call with the encrypted session key to the USC server 202A in step 608 to create a folder for the user on the USC server 202A. In this instance, the API call is:

sd12345.zzz.net/folder_add.api?cS=<session key>&folder=<filename>

Similarly, API calls are made to delete folder, rename files, move files, or any such file and folder management functions that are typically required for managing a user's content. Such content typically includes photos, video, images, documents and the like content.

Thereafter, in step 610, the Web application 106 returns a Web page to the user to indicate if the file or folder operation is successful or unsuccessful.

The distributed USC system provides a secure mechanism for user-specific content to be stored and retrieved by the Web application 106 and the like applications. As objects are typically large in byte size in relation to an entire HTML Web page in which the objects are embedded, the distributed USC system helps speed up the process of storing and retrieving the user-specific objects.

Similar API calls exist for file and folder manipulation in relation to well-known functions such as rename, move, copy, download, upload, as well as an API call to e-mail files. An API call also exists for the Web application 106 to obtain an entire file system tree for each user. In addition, API calls exist for user account management in relation to functions such as changing passwords, adjusting storage allocation and bandwidth allocation for each user.

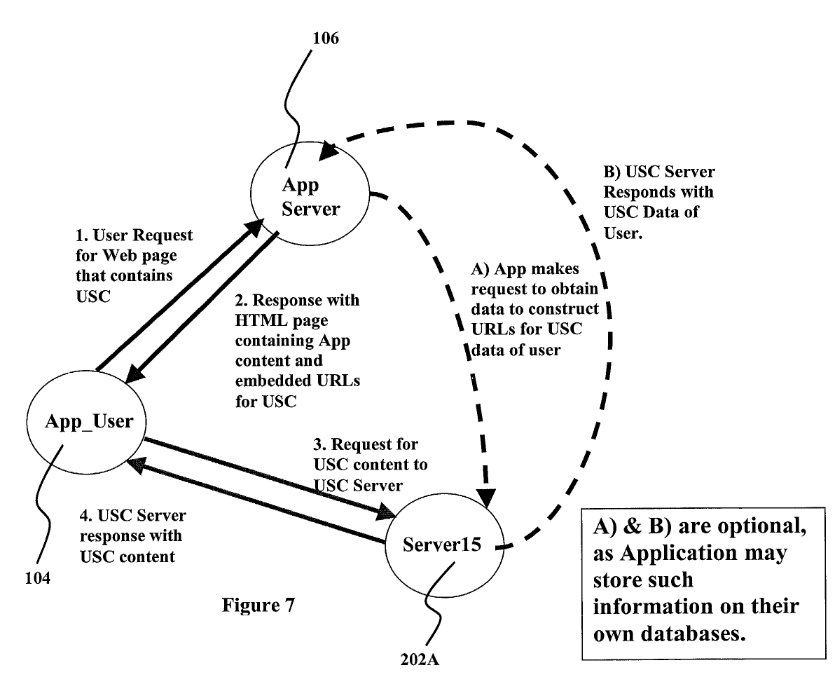

FIG. 7 is a data flow diagram which illustrates the interaction between distributed USC system and the Web application 106 when responding to a HTTP request for Web pages that contain user-specific content.

As described in the foregoing, the Web application 106 obtains a session key from the USC server 202A after a user performs a login. Subsequently, as the user uploads a file, the client machine 104 makes an API call for the upload directly to the USC server 202A, using:

sd12345.zzz.net/file_upload.api?cS=<session

key>&file=<filename>&callback=<url>

The Web application 106 provides a callback URL at the end of the API call which the USC server 202A uses to redirect the user back to the Web application 106 once the upload is completed.

Similarly, API calls are made to retrieve and download the user's previously uploaded content directly from the USC server 202A. In this way, user-specific content is uploaded and retrieved from the most optimum location, i.e. from the USC server 202A closest to the user. Such content typically includes photos, video, images, documents and the like objects.

API calls also exist to allow for sharing of files and folders among a number of users. The Web application 106 may choose to allow the users to share files and folders. When a user chooses to share a file or folder out to another user, the Web application 106 simply makes an API call to add a shared resource, and specify the identity of the recipient and the type of sharing privilege accorded, either a download only, upload & download, or public access. The distributed USC system then creates a sharing relationship for the shared resource by way of making an entry into a shared resources table, and an entry is also made in a recipient account to indicate that a recipient has access to a shared resource. The sharing relationship also has limited access attributes that may be used. These attributes include expiry dates and limitation of the number of access to shared resources. On reaching the expiry dates, the sharing relationship expires and the shared resource is no longer available to the recipient of a sharing relationship.

API calls also exist to allow for the Web application 106 to selectively replicate user's data either selectively or entirely to selected locations or all locations. The Web application 106 may specify a priority for the replication, indicating if the replication has urgent, high or normal priority. The distributed USC system then sets up the user's secondary account on a destination USC server 202, sets up resources for replication, and if a folder is specified or the entire content in the user's account is specified, the distributed USC system recursively travels down the folder or user's file system tree and sets up all the objects for replication. Meanwhile, the user's access to data is not interrupted during the replication process. The distributed USC system automatically checks for replicated data at the point of access. If the replicated USC server 202 at the point of access does not contain the replicated file, because replication may take some time, the distributed USC system automatically points back to the origin USC server 202A.

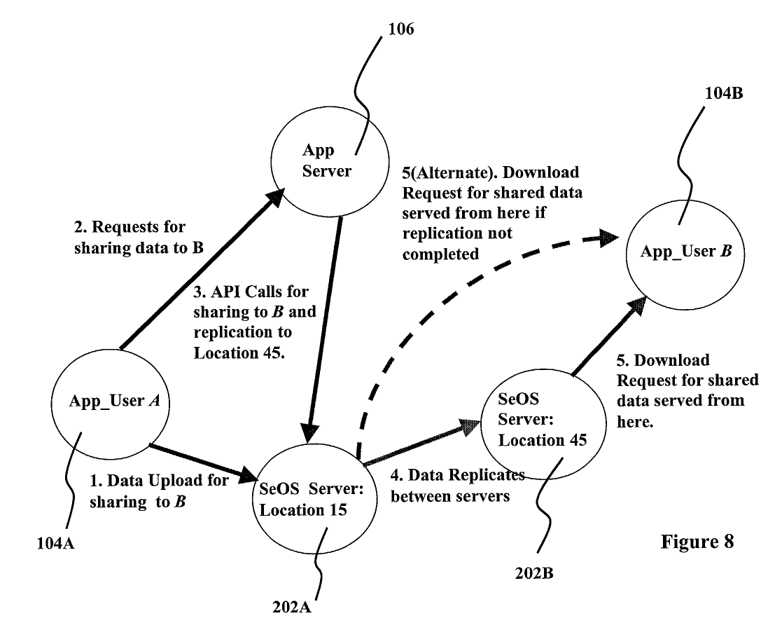

The global computer network architecture or framework allows for a system of sharing and replication to be used together to provide for quicker access to shared resources. FIG. 8 illustrates how this system may be put to effective use. The Web application 106 allows a user A 104A to share out an object to a recipient in another location known as user B 104B, and allows user A 104A to choose whether to have that object replicated to a USC server 202B, which is user B's 104B storage site. The recipient, user B 104B, may then download the shared object quickly as the object is located in the USC server 202B at the same location which user B's 104B data is also stored. The distributed USC system also handles the replication without interrupting user B's 104B access to the shared object, because if at the time of access the replication of the shared object is not complete at the USC server 202B, access is redirected back to the origin USC server 202A. Once replication is completed, the distributed USC system automatically checks to see if the shared object is replicated at the recipient USC server 202B and the object is thereafter served from the recipient USC server 202B if replication is successful. In this way, user access is not interrupted, and in most cases, even enhanced by the quicker downloads.

The computer network architecture and framework by providing for replication features provides the capability for the Web application 106 to be fault-tolerant.

User-specific content is distributed to several locations, thereby minimizing the risk of inaccessibility of user-specific content due to a shutdown at a particular hosting location if the content is centrally hosted. In addition, replication of user-specific content ensures that user access is not interrupted if a hosting location goes down.

The computer network architecture or framework by providing for sharing and replication features also provides the capability for a controlled content distribution and delivery service. Such a service is suitable for Web services that conduct commerce on electronic media, for example, software and music sales via downloads. The Web service providers might choose to have accounts on various locations with data replicated on all of these locations. For example, software for sale may be replicated in all locations in the world, or music for sale may be replicated in certain locations where the music is popular. As a customer purchases media through such a Web service, the Web service creates an account for the customer at a location most appropriate to the customer and then shares out the media to other users with either an expiry date or with limited number of access. In this way, the Web service is able to harness from the computer network architecture and sell electronic media such as music and software with good performance in media delivery, especially since such media are relatively large in byte size. Such Web services which benefit from the computer network architecture, are able to provide a better service to customers, and at the same time be able to control the distribution by ensuring only those customers who have purchased the media are able to download from these locations.

By providing replication features, the computer network architecture or framework provides a fault-tolerance for user-specific content. Data for a user can be replicated in more than one location, ensuring availability as well as improving delivery performance from various locations during downloads.

In the foregoing manner, a computer network architecture or framework providing a distributed USC system that allows for the storage, manipulation, and delivery of user-specific content on a global scale is described. Although a number of embodiments are described, it is apparent to one skilled in the art in view of this disclosure that numerous changes and/or modifications may be made without departing from the scope and spirit of the invention.

1. A method for storing and retrieving user-specific content in a client-server computer network, the method comprising the steps of:
sending, from a first computer, a request relating to user-specific content to a second computer in a client-server computer network;
determining a third computer in the client-server computer network which is geographically proximal to the first computer;
redirecting, by the second computer, the request to the third computer; and
providing a user-specific content transaction between the first and third computers.

2. The method as in claim 1, wherein when the request is a first request the step of determining the third computer includes the step of redirecting, by the second computer, the request first to a fourth computer in the client-server computer network,

3. The method as in claim 2, wherein the step of determining the third computer further includes the step of redirecting, by the fourth computer, the request next to a plurality of computers in the client-server computer network.

4. The method as in claim 3, wherein the step of determining the third computer further includes the step of measuring the response time of the communication between each of the plurality of computers and the first computer.

5. The method as in claim 4, wherein the step of determining the third computer further includes the step of determining the shortest response time and identifying as the third computer one of the plurality of computers measuring the shortest response time.

6. The method as in claim 5, wherein the step of determining the third computer further includes the step of responding, by the third computer, to the first request to the first computer.

7. The method as in claim 6, wherein the step of determining the third computer further includes the step of causing the first computer to provide the second computer with details relating to the third computer.

8. The method as in claim 7, wherein the step of determining the third computer further includes the step of creating a new account at the third computer for the first computer.

9. The method as in claim 1, wherein the step of redirecting, by the second computer, the request to the third computer includes the step of providing, by the third computer, a session key to the second computer.

10. The method as in claim 9, wherein the step of redirecting, by the second computer, the request to the third computer further includes the step of modifying the request using the session key before redirecting the request to the third computer.

11. A system for storing and retrieving user-specific content in a client-server computer network, the system comprising:
means for sending, from a first computer, a request relating to user-specific content to a second computer in a client-server computer network;
means for determining a third computer in the client-server computer network which is geographically proximal to the first computer;
means for redirecting, by the second computer, the request to the third computer; and
means for providing a user-specific content transaction between the first and third computers.

12. The system as in claim 11, wherein when the request is a first request the means for determining the third computer includes means for redirecting, by the second computer, the request first to a fourth computer in the client-server computer network,

13. The system as in claim 12, wherein the means for determining the third computer further includes means for redirecting, by the fourth computer, the request next to a plurality of computers in the client-server computer network.

14. The system as in claim 13, wherein the means for determining the third computer further includes means for measuring the response time of the communication between each of the plurality of computers and the first computer.

15. The system as in claim 14, wherein the means for determining the third computer further includes means for determining the shortest response time and identifying as the third computer one of the plurality of computers measuring the shortest response time.

16. The system as in claim 15, wherein the means for determining the third computer further includes means for responding, by the third computer, to the first request to the first computer.

17. The system as in claim 16, wherein the means for determining the third computer further includes means for causing the first computer to provide the second computer with details relating to the third computer.

18. The system as in claim 17, wherein the means for determining the third computer further includes means for creating a new account at the third computer for the first computer.

19. The system as in claim 11, wherein the means for redirecting, by the second computer, the request to the third computer includes means for providing, by the third computer, a session key to the second computer.

20. The system as in claim 19, wherein the means for redirecting, by the second computer, the request to the third computer further includes means for modifying the request using the session key before redirecting the request to the third computer.
